(19) United States
(12) Patent Application Publication
(10) Pub. No.: US 2014/0063496 A1
(43) Pub. Date: Mar. 6, 2014

(54) SPECTROPHOTOMETER

(71) Applicant: SHIMADZU CORPORATION, Kyoto-shi (JP)

(72) Inventor: Michiaki OWA, Kyoto-shi (JP)

(73) Assignee: SHIMADZU CORPORATION, KYOTO-SHI, KYOTO (JP)

(21) Appl. No.: 14/011,982

(22) Filed: Aug. 28, 2013

(30) Foreign Application Priority Data
Aug. 31, 2012 (JP) 2012-191912

(51) Int. Cl. G01J 3/02

(52) U.S. Cl. CPC G01J 3/0286
USPC 356/319

(57) ABSTRACT

Provided is a spectrophotometer capable of further reducing a change in temperature of a spectroscopic unit that houses a spectroscopic element, a sample, and the like therein, compared with conventional spectrophotometers. A spectrophotometer 1 includes: a light source chamber 10; a spectroscopic chamber 20 separated from the light source chamber 10 with a heat insulating section located therebetween, the spectroscopic chamber 20 including at least a spectroscopic element 24, a sample chamber 22, and a detector 25; a temperature measurer 40 measuring a temperature inside of the spectroscopic chamber 20; a temperature regulator 50 heating and/or cooling the inside of the spectroscopic chamber 20; and a controller 31 acquiring temperature information from the temperature measurer 40 and controlling the temperature regulator 50 to operate so as to keep the inside of the spectroscopic chamber 20 at a predetermined preset temperature.

### TECHNICAL FIELD

The present invention relates to a spectrophotometer. In particular, the present invention relates to a spectrophotometer including a spectroscopic chamber separated from a light source.

### BACKGROUND ART

In a spectrophotometer, a sample is irradiated with light emitted from a light source, and light after interaction with the sample (for example, transmitted light) is subjected to wavelength separation by a spectroscopic element, whereby the intensity of each wavelength is detected. In such a spectrophotometer, for example, a deuterium lamp is used as the light source, and a diffraction grating is used as the spectroscopic element.

In the case where the deuterium lamp is used as the light source, heat amounting to tens of watts is generated from the light source. If the heat is transferred to the diffraction grating used as the spectroscopic element, the spacing of the diffraction grating increases so that spectroscopic characteristics change.

In order to prevent the heat generated from the light source from being transferred to the spectroscopic element as described above, a light source chamber that houses the light source therein is separated from a spectroscopic chamber that houses the spectroscopic element, a sample cell, a detector, and the like therein, a heat insulating material is disposed between the two chambers, and only light for analysis is allowed to pass therethrough. In other cases, the heat generated from the light source chamber is actively released. For example, in a spectrophotometer described in JP-A 8-233659, one end of a heat pipe is attached to a light source chamber, and another end thereof is air-cooled by a fan, whereby heat in the light source chamber is disposed of therefrom to suppress an influence of the heat on a spectroscopic chamber that is connected to the light source chamber with a heat insulating material located therebetween.

### BACKGROUND ART DOCUMENT

### Patent Document

[Patent Document 1] JP-A 8-233659

### DISCLOSURE OF THE INVENTION

### Problems to be Solved by the Invention

In high-performance liquid chromatographs (HPLCs), an analysis of a very small amount of sample has come to be required in recent years, where the flow rate of a mobile phase is reduced to about one tenth of that in conventional cases. In such HPLCs with a reduced flow rate, the light is multiply reflected in a flow cell in order to compensate for the decrease in the amount of light absorption due to the decrease in the amount of sample component. In this case, in addition to a change in temperature of a spectroscopic element, a slight change in temperature of a mobile phase and temperature around the sample also have a significant influence on analysis results.

An objective of the present invention is to provide a spectrophotometer capable of further reducing a change in temperature of a spectroscopic unit that houses a spectroscopic element, a sample, and the like therein, compared with conventional spectrophotometers.

### Means for Solving the Problems

The present invention achieved to solve the aforementioned problems provides a spectrophotometer including:
a) a light source chamber;
b) a spectroscopic chamber separated from the light source chamber with a heat insulating section located therebetween, the spectroscopic chamber including at least a spectroscopic element, a sample chamber, and a detector;
c) a temperature measurer measuring a temperature inside of the spectroscopic chamber;
d) a temperature regulator heating and/or cooling the inside of the spectroscopic chamber; and
e) a controller acquiring temperature information from the temperature measurer and controlling the temperature regulator to operate so as to keep the inside of the spectroscopic chamber at a predetermined preset temperature.

In the present invention, the temperature of the spectroscopic chamber is feedback controlled based on temperature information from the temperature measurer, and hence the temperature inside of the spectroscopic chamber can be kept at the predetermined preset temperature with high accuracy. Further, the temperature regulator regulates the temperature of the entire space inside of the spectroscopic chamber, and hence the temperatures of the spectroscopic element, the sample chamber, and the detector provided therein are regulated at the same time. Hence, a difference in temperature thereamong is less likely to occur, and highly accurate spectrometry can be performed.

When the spectroscopic element, the sample chamber, and the detector are placed in the spectroscopic chamber so as to be spaced apart from one another at necessary intervals, an effect of temporal stability can also be achieved in addition to the above-described spatial uniformity. That is, since a relatively large space exists in the spectroscopic chamber because the spectroscopic element, the sample chamber, and the detector are placed in the spectroscopic chamber so as to be spaced apart from one another at necessary intervals, and the temperature of the entire large space is regulated in the present invention, a temporal change (fluctuation) in temperature is smaller, and an analysis with high stability and excellent reproducibility can be performed.

Note that the light source chamber may also be provided with a separate cooler such as a heat radiator, or a temperature regulator.

In the spectrophotometer according to the present invention, it is desirable that the preset temperature be higher than room temperature.

Even when the light source chamber and the spectroscopic chamber are separated from each other and a heat insulating material is disposed between the two chambers, or heat generated from the light source chamber is actively released, part of the heat generated from the light source chamber is transmitted to the spectroscopic chamber through external air. Hence, the temperature in the spectroscopic chamber tends to be higher than the room temperature. If the preset temperature is higher than the room temperature, the temperature in the spectroscopic chamber can be kept constant more stably and efficiently.

### Effects of the Invention

In a spectrophotometer according to the present invention, the temperature of a spectroscopic chamber separated from a light source chamber is feedback controlled based on temperature information from a temperature measurer. Hence, the spectrophotometer can further reduce a change in temperature of a spectroscopic unit that houses a spectroscopic element, a sample, and the like therein, compared with conventional spectrophotometers.

### BRIEF DESCRIPTION OF THE DRAWINGS

FIG. 1 is a main part configuration diagram of an embodiment of a spectrophotometer according to the present invention.

FIG. 2 are graphs respectively showing temporal changes in absorbance that are measured using a conventional spectrophotometer and the spectrophotometer according to the present embodiment.

### BEST MODES FOR CARRYING OUT THE INVENTION

An embodiment of a spectrophotometer according to the present invention is described below with reference to the drawings.

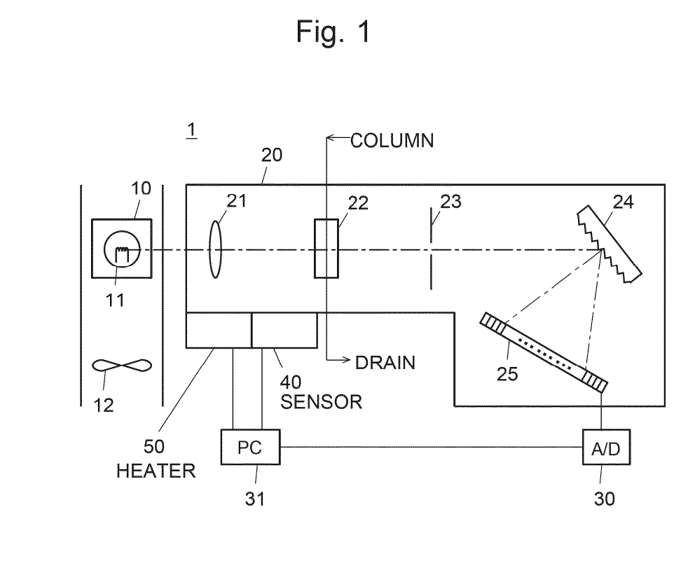

A spectrophotometer 1 of the present embodiment is used as a detection unit of a liquid chromatograph, and generally includes a light source chamber 10 and a spectroscopic chamber 20 (FIG. 1). The light source chamber 10 is placed in a space separated from the spectroscopic chamber 20 with a heat insulating space located therebetween.

A deuterium lamp 11 is placed in the light source chamber 10. A fan 12 for releasing heat generated in the light source chamber 10 is also placed therein.

In the spectroscopic chamber 20, a condensing lens 21, a sample cell 22, a slit 23, a diffraction grating 24, and a photodiode array detector 25 are placed on an optical path in the stated order from the light source chamber 10 side. An A/D converter 30 is connected to the photodiode array detector 25, and the A/D converter 30 is also connected to a computer 31.

Further, a temperature sensor 40 and a heater 50 are attached to an outer wall of the spectroscopic chamber 20. The temperature sensor 40 measures the temperature in the spectroscopic chamber 20. The temperature sensor 40 and the heater 50 are both connected to the computer 31.

An operation of the spectrophotometer of the present embodiment is described. A mobile phase and components of sample temporally separated in a column connected on the upstream side sequentially flow into the sample cell 22, and are discharged from the sample cell 22 to a drain connected on the downstream side. Light emitted from the deuterium lamp 11 is condensed by the condensing lens 21, and the components and the mobile phase passing through the sample cell 22 are irradiated with the condensed light. The light that has passed through the sample cell 22 passes through the slit 23, and then enters the diffraction grating 24. The light that has entered the diffraction grating 24 is subjected to wavelength separation, comes out of the diffraction grating 24, and is detected by the photodiode array detector 25. A detection signal from the photodiode array detector 25 is A/D converted by the A/D converter 30, and is inputted to the computer 31.

A user makes temperature settings of the spectroscopic chamber 20 on the computer 31, before activation of the spectrophotometer 1. In the spectrophotometer 1 of the present embodiment, the user sets the temperature of the spectroscopic chamber 20 to a value higher than room temperature. When the user activates the spectrophotometer 1 after completion of the temperature settings, the temperature sensor 40 starts measurement of the temperature in the spectroscopic chamber 20, and displays the measured temperature and the temperature set in advance by the user on a display unit (not shown) connected to the computer 31. Further, the computer 31 compares the temperature in the spectroscopic chamber 20 acquired through the temperature sensor 40, with the temperature set in advance by the user, and causes the heater 50 to operate for heating the inside of the spectroscopic chamber 20, until the two temperatures become equal. Then, when the temperature in the spectroscopic chamber 20 reaches the temperature set by the user, the computer 31 stops the operation of the heater 50.

In the spectrophotometer 1 of the present embodiment, because the temperature of the entire space inside of the spectroscopic chamber 20 is regulated, the temperatures of the sample cell 22, the diffraction grating 24, the photodiode array detector 25, and the like provided therein are regulated at the same time. Hence, a difference in temperature thereamong is less likely to occur, and highly accurate spectrometry can be performed. In addition to such spatial uniformity, an effect of temporal stability can also be produced. The condensing lens 21, the sample cell 22, the slit 23, the diffraction grating 24, and the photodiode array detector 25 are placed in the spectroscopic chamber 20 so as to be spaced apart from one another at necessary intervals, and hence a relatively large space exists in the spectroscopic chamber 20. In the spectrophotometer 1 of the present embodiment, because the temperature of the entire large space is regulated, a temporal change (fluctuation) in temperature is smaller, and an analysis with high stability and excellent reproducibility can be performed.

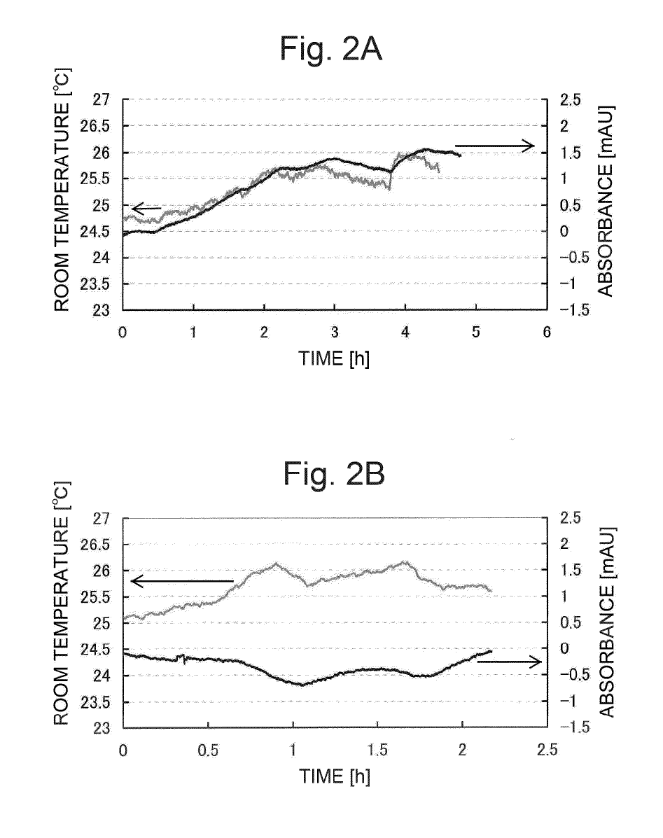

In order to check an effect produced by feedback controlling the temperature in the spectroscopic chamber 20 based on temperature information from the temperature sensor 40 as in the spectrophotometer 1 of the present embodiment, baseline measurement was performed for each of the cases where the feedback control was performed and where the feedback control was not performed. Water was circulated as the mobile phase in the sample cell 22. FIG. 2A and FIG. 2B each show a change in absorbance at a detection wavelength of 254 nm obtained from the measurement result and a change in room temperature during the measurement. FIG. 2A is a graph showing a change in absorbance obtained by performing the baseline measurement without the feedback control, and FIG. 2B is a graph showing a change in absorbance obtained by performing the baseline measurement while performing the feedback control with the temperature of the spectroscopic chamber 20 being set to 37° C.

In the case where a change in absorbance was measured without the feedback control, as shown in FIG. 2A, a fluctuation of the absorbance synchronized with a fluctuation of room temperature remarkably appeared. During the time of the measurement, the absorbance shifted by 1.60 mAU while the fluctuation of the room temperature was 1.2° C., so that the fluctuation ratio was 1.33 mAU/° C. The reason for this is considered to be as follows.

As the temperature in the spectroscopic chamber 20 changes together with a change in room temperature, the dimensions of the diffraction grating 24 change, and thus the spacing changes. As a result, spectroscopic characteristics of the diffraction grating 24 change, and the wavelength of light that enters a predetermined portion of the photodiode array detector 25 changes. The intensity of light emitted from the deuterium lamp 11 is different for each wavelength. Hence, if the spectroscopic characteristics of the diffraction grating 24 change, the intensity of light detected at the same portion of the photodiode array detector 25 changes, and this appears as a drift of the absorbance.

Further, the magnitude of dark current generated in the photodiode array detector 25 also fluctuates depending on the temperature. At the time of the baseline measurement, correction is performed for offsetting a value of dark current from the photodiode array detector 25. Hence, if the magnitude of the dark current fluctuates, this appears as a drift of the absorbance.

In contrast, in the case where a change in absorbance was measured with the feedback control, as shown in FIG. 2B, a fluctuation of the absorbance synchronized with a fluctuation of room temperature did not occur. During the time of the measurement, the fluctuation of the absorbance was 0.60 mAU while the fluctuation of the temperature was 1.0° C., so that the fluctuation ratio was 0.60 mAU/° C. That is, it was confirmed that the fluctuation of the absorbance could be suppressed to be equal to or less than half by feedback controlling the temperature in the spectroscopic chamber 20.

The above-mentioned embodiment is given as a mere example, and can be changed and modified as appropriate within the spirit of the present invention. The deuterium lamp, the diffraction grating, the sample cell, and the photodiode detector are all given as mere examples, and may be replaced with other elements, as a matter of course.

In the above-mentioned embodiment, the preset temperature is set to be higher than the room temperature, and the inside of the spectroscopic chamber 20 is heated using the heater 50. Alternatively, the preset temperature may be set to be lower than the room temperature, and the inside of the spectroscopic chamber 20 may be cooled using a cooler, to be thereby kept at the preset temperature. Still alternatively, the preset temperature may be set to be equivalent to the room temperature, and a temperature regulator capable of both heating and cooling may be used.

In the above-mentioned embodiment, the user makes the temperature settings on the computer 31. Alternatively, a temperature sensor that measures the room temperature may be provided, and the computer 31 may make such temperature settings that the temperature becomes higher (or lower) by a predetermined value than the room temperature, at the same time as the activation of the spectrophotometer 1 by the user. Further, in this configuration, the room temperature may be measured after the elapse of a certain period of time from the activation of the spectrophotometer 1, and the computer 31 may make again such temperature settings that the temperature becomes higher (or lower) by a predetermined value than the room temperature. Alternatively, instead of after the elapse of a certain period of time, the room temperature may be measured again when the temperature in the spectroscopic chamber 20 approaches the preset temperature set at the time of the activation, and the computer 31 may make again such temperature settings that the temperature becomes higher (or lower) by a predetermined value than the room temperature.

In the above-mentioned embodiment, considering that heat generated in the light source chamber 10 is transferred to the spectroscopic chamber 20 through its surrounding air, the heater 50 is placed at a position near the light source chamber 10, and the temperature sensor 40 is placed adjacently to the heater 50, in order to shorten the time necessary for the inside of the spectroscopic chamber 20 to reach thermal equilibrium, but the number and placement of each of the heater 50 and the temperature sensor 40 can be changed as appropriate. For example, in the case where the spectroscopic chamber 20 has a large space, a plurality of the heaters 50 and a plurality of the temperature sensors 40 may be provided. Further, in the spectroscopic chamber 20, the temperature sensor 40 may be placed in the vicinity of, particularly, an optical element or the like whose characteristics easily change in accordance with a change in temperature in the spectroscopic chamber 20, so that the temperature of the optical element or the like may be kept constant with high accuracy.

Note that the spectrophotometer according to the present invention can be suitably used as the detection unit of the liquid chromatograph, but may be used as a detector of another analyzing apparatus, as a matter of course.

### EXPLANATION OF NUMERALS

1 . . . Spectrophotometer
10 . . . Light Source Chamber
11 . . . Deuterium Lamp
12 . . . Fan
20 . . . Spectroscopic Chamber
21 . . . Condensing Lens
22 . . . Sample Cell
23 . . . Slit
24 . . . Diffraction Grating
25 . . . Photodiode Array Detector
30 . . . A/D Converter
31 . . . Computer
40 . . . Temperature Sensor
50 . . . Heater

1. A spectrophotometer comprising:
a) a light source chamber;
b) a spectroscopic chamber separated from the light source chamber with a heat insulating section located therebetween, the spectroscopic chamber including at least a spectroscopic element, a sample chamber, and a detector;
c) a temperature measurer measuring a temperature inside of the spectroscopic chamber;
d) a temperature regulator heating and/or cooling the inside of the spectroscopic chamber; and
e) a controller acquiring temperature information from the temperature measurer and controlling the temperature regulator to operate so as to keep the inside of the spectroscopic chamber at a predetermined preset temperature.

2. The spectrophotometer according to claim 1, wherein the spectroscopic element, the sample chamber, and the detector are placed in the spectroscopic chamber so as to be spaced apart from one another at necessary intervals.

3. The spectrophotometer according to claim 1, wherein
the preset temperature is higher than room temperature.

4. The spectrophotometer according to claim 1, being used as a detection unit of a liquid chromatograph.

5. The spectrophotometer according to claim 2, wherein
the preset temperature is higher than room temperature.

6. The spectrophotometer according to claim 2, being used as a detection unit of a liquid chromatograph.

7. The spectrophotometer according to claim 3, being used as a detection unit of a liquid chromatograph.

8. The spectrophotometer according to claim 5, being used as a detection unit of a liquid chromatograph.
